(19) United States
(12) Patent Application Publication
(10) Pub. No.: US 2017/0103420 A1
(43) Pub. Date: Apr. 13, 2017

(54) Generating a Contextual-Based Sound Map

(71) Applicant: ArcSecond, Inc., San Diego, CA (US)

(72) Inventor: Vaidyanathan P. Ramasarma, San Diego, CA (US)

(21) Appl. No.: 15/292,116

(22) Filed: Oct. 12, 2016

Related U.S. Application Data
(60) Provisional application No. 62/240,462, filed on Oct. 12, 2015.

(51) Int. Cl. G06Q 30/02; G01S 3/80

(52) U.S. Cl. CPC G06Q 30/0261; G01S 3/80; G06Q 30/0267

(57) ABSTRACT

Acoustic information is obtained from an acoustic sensor of a mobile computing device. Location information of the mobile computing device can be obtained from location sensors of the mobile computing device. A context of the acoustic information can be determined and can have an assigned context attribute. A context-based acoustic map can be generated based on the context and the location information. Offers can be presented to a user of the mobile computing device. The offer can have an offer attribute matching the context attribute and a location attribute matching the location information.

### CROSS-REFERENCE TO RELATED APPLICATIONS

The present application claims priority to and the benefit of U.S. Provisional Patent No. 62/240,462 filed on Oct. 12, 2015 and titled “SYSTEM AND METHOD FOR SOUND INFORMATION EXCHANGE,” the disclosure of which is incorporated herein by reference in its entirety.

### TECHNICAL FIELD

The subject matter described herein relates to generating contextual-based sound maps of an environment in the vicinity of a sound sensor.

### BACKGROUND

The pervasiveness of mobile devices and the large volume of data that they can collect has brought the advent of new technologies. In particular, the Big Data industry has exploited these technologies and is providing in-depth analysis of events and trends to provide precision reports and recommendations. Technical capabilities in most mobile devices, for example Global Positioning System (GPS), motion sensors, environmental sensors, or the like, can be used in concert to facilitate analysis of the way in which mobile devices are used, where they are used, and by whom they are used. Crowd-sourcing of such information from a plurality of mobile devices can be used to analyze whole groups of people and detect trends that would be otherwise opaque to the casual observer.

### SUMMARY

In one aspect, a method is provided having one or more operations. In another aspect a system is provided including a processor configured to execute computer-readable instructions, which, when executed by the processor, cause the processor to perform one or more operations.

The operations can include obtaining acoustic information from an acoustic sensor of a mobile computing device. Acoustic information can be obtained from a plurality of acoustic sensors of a plurality of mobile computing devices. The plurality of mobile computing devices can belong to a user group having a plurality of users, the plurality of users having at least one common attribute.

Location information of the mobile computing device can be determined. Determining location information can include: obtaining geographical coordinates from a geographical location sensor of the mobile computing device; comparing the obtained acoustic information with a database of acoustic profiles, the acoustic profiles associated with geographical locations; comparing the obtained acoustic information from a first mobile computing device of the plurality of mobile computing devices with obtained acoustic information from other mobile computing device of the plurality of mobile computing devices; or the like.

A context of the acoustic information can be determined. The context can have a context attribute. Determining the context of the acoustic information can include determining an acoustic type of acoustics associated with the obtained acoustic information. One or more entity types capable of generating acoustics having the acoustic type can be determined. Context attributes can be associated with geographical locations.

Determining the context of acoustic information can include determining that the acoustic type is human speech. A transcript of the human speech can be generated. A context of the human speech can be determined, wherein the context has a context attribute indicating a subject of the human speech.

A context-based acoustic map can be generated based on the context and the location information. Generating a context-based map can include obtaining a map of a geographical region associated with the location information of the mobile computing device. A graphical representation of the context of the acoustic information can be overlaid on the map.

An offer can be presented to a user of the mobile computing device. The offer can have an offer attribute matching the context attribute and a location attribute matching the location information. An offer having an offer attribute consistent with the subject of the human speech can be selected. The offer can be presented to the user on a display device of the mobile computing device. The offer can be presented in proximity to a subject of the offer.

In some variations, acoustic information from the plurality of acoustic sensors can be received over a period of time. A context trend can be determined based on the context of the acoustic information received over the period of time. A likely future event can be predicted based on the context trend. The offer to the user can be associated with the likely future event.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a mobile device, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a schematic representation of a system having one or more features consistent with the present description;

FIG. 2 illustrates a schematic representation of a mobile computing device associated with a system having one or more elements consistent with the present description;

FIG. 3 illustrates a method having one or more elements consistent with the present description;

FIG. 4 illustrates a method having one or more elements consistent with the present description;

FIG. 5 illustrates a method having one or more elements consistent with the present description; and,

FIG. 6 illustrates a method having one or more elements consistent with the present description.

### DETAILED DESCRIPTION

Contextual based advertising occurs when advertising presented to a recipient is based on something about that recipient. The advertising may be based on prior websites visited, prior products purchased, the current weather, the time of year, the time of day, a life event associated with the recipient, or the like. With the pervasiveness of mobile devices, for example smartphones, tablets, or the like, the ability to obtain information about the recipient has increased. Additional contextual information can be obtained.

The presently described subject matter takes advantage of sensors on the mobile computing devices to determine additional context associated with recipients of advertisements and provide contextual offers to recipients of the mobile computing devices. For example, acoustics information can be obtained from an acoustic sensor of the mobile computing devices. An acoustic context can be determined for the acoustic information and that acoustic context can be used to provide context-relevant offers to users of the mobile computing device or to others in the vicinity of the mobile computing device.

An example of context-relevant offers can include offers for baby products being presented to a user of a mobile computing device when acoustic information associated with a crying baby has been received from the mobile computing device over a defined period of time or with a defined frequency. Another example includes providing offers for upgrades when the context associated with the obtained acoustic information indicates that the user of a mobile computing device is at an airport. Another example includes providing offers for goods in a supermarket with the context associated with the obtained acoustic information indicates that the user is in a supermarket.

Acoustics can be provided through sounds, perceiveable sensations caused by the vibration of air or some other medium, electronically produced or amplified sound, sounds from natural sources, or the like.

Sound can be produced by in nature, for example, a bird chirping, a baby crying, people talking, or the like. Sounds can be produced naturally, but be transmitted electronically, for example, a bird chirping being recorded with a microphone and then played through a speaker. Sounds can be produced by artificial means, for example, by a synthesizer, from a machine, such as a car or an airplane, or the like. Sounds can occur outside of the abilities of a human to hear the sound, for example, sounds can be ultrasonic or infrasonic.

Throughout this disclosure, the terms sound, audio, and acoustic may be used interchangeably.

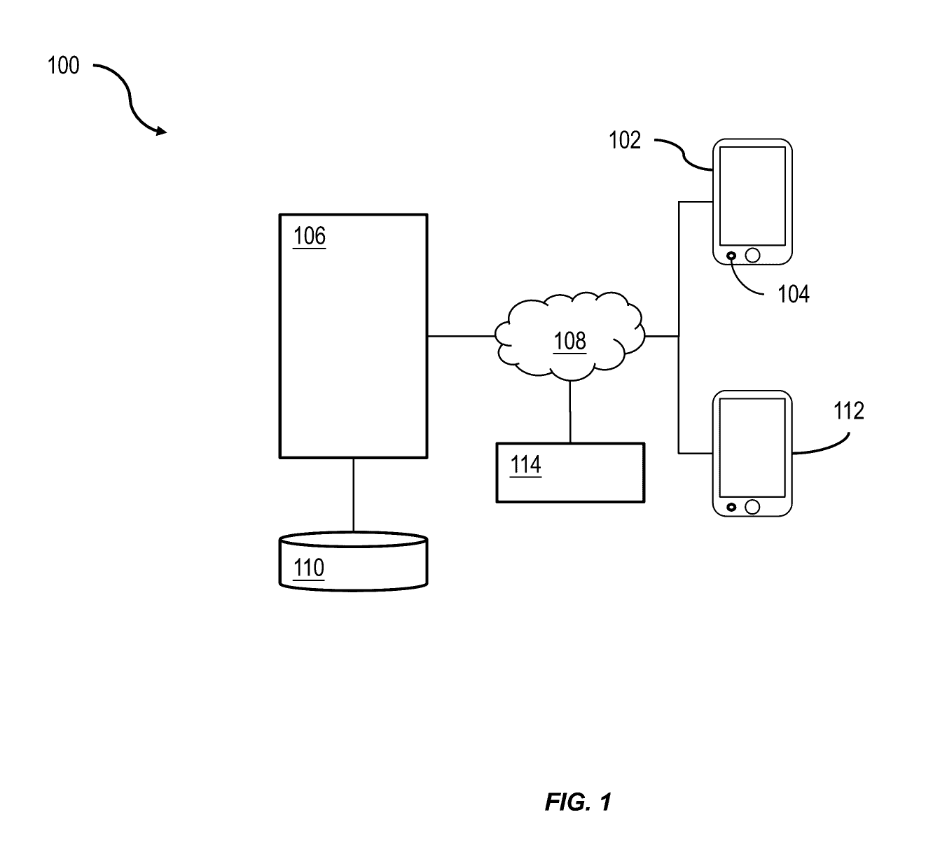

FIG. 1 is a schematic representation of a system 100 having one or more features consistent with the present description. The system 100 may comprise a mobile computing device 102. The mobile computing device 102 may include an acoustic sensor 104. The acoustic sensor 104 may be, for example, a microphone. The mobile computing device 102 may be configured to obtain acoustic information using the acoustic sensor 104. The acoustic information may be obtained continuously or periodically. The acoustic information may be obtained with permission of the user of the mobile computing device 102 or may be obtained without the permission of the user of the mobile computing device 102.

In some variations, the mobile computing device 102 may be configured to transmit the acoustic information to a server 106. The mobile computing device 102 may be in electronic communication with the server 106 over a network 108, for example, the Internet.

Location information of the mobile computing device 102 can be obtained. The location information may be obtained from one or more geographical location sensors associated with the mobile computing device 102. One example of a geographical location sensor includes a Global Positioning System sensor, although this is not intended to be limiting and the presently described subject matter contemplates many different types of geographical location sensors.

Location information of the mobile computing device 102 can be obtained using wireless communication technology. For example, a signal strength or a time delay of a signal between a wireless communication tower and the mobile computing device 102 can be used to determine the location of the mobile computing device 102. Location information can be obtained based on the mobile computing device 102 being connected to a particular access point or communicating with a particular wireless communication device. For example, the mobile computing device 102 may be connected to a WiFi hub, or may interact with a Bluetooth™ beacon.

Location information of the mobile computing device 102 can be determined using the acoustic information. For example, the acoustic information obtained by the mobile computing device 102 can be compared to a database 110 of acoustic sounds that are themselves associated with geographical locations. In some variations, the system 100 can include one or more other mobile computing devices 112. Acoustic information obtained by a mobile computing device 102 can be compared to acoustic information obtained by other mobile computing devices including mobile computing device 112. The acoustic information from all mobile computing devices can be compared and a determination can be made as to which mobile computing devices are within the same geographical area based on the mobile computing devices obtaining the same or similar acoustic information at the same or similar time.

Location information of the mobile computing device 102 can be determined by one or more of the mobile computing device 102, the server 106, one or more other mobile computing devices 112, or the like.

A context of the acoustic information can be determined. In some variations, a context can have a context attribute. A context attribute may indicate a type of the acoustic information. For example, a context attribute may be indicative of a particular location, an entity of the source of the acoustic information, a condition of the entity of the source of the acoustic information, a condition of the environment in the vicinity of the mobile computing device at which the acoustic information has been obtained, or the like.

The context of the acoustic information can be determined by the mobile computing device 102, the server 106, one or more other mobile computing device 112, or the like.

A context-based acoustic map can be generated. The context-based acoustic map can be based on the context of the acoustic information obtained from the mobile computing device 102 and the location information obtained for the mobile computing device 102.

Mobile computing devices 102 can be used by active user members and passive user members of an application service provided on the mobile computing devices 102. Active members can be defined as members having mobile computing devices that transmit information and/or receive information with the server 106. The system 100 can include one or more passive agents 114. Passive agents 114 can be defined as those agents that are stationary agents embedded into infrastructure elements in the given geographical area. For example, a point of interest may include a passive agent 114. The passive agent 114 may be embedded in a street light fixture. In some variations, active members may have mobile computing devices 102 configured to query the server 106.

Active user members may be grouped into groups of users. Users in a groups of users may have a common user attribute. A common user attribute can include users being at the same location, demographic information, a common link, such as social media connections, or the like. As users enter and leave a points-of-interest, location updates may be obtained from users of the mobile computing devices 102.

In some variations, users may be grouped based on similarities in their respective ambient audio signatures. A coarse location of a given user or a plurality of users can be determined based on correlating the audio snapshot received from mobile computing devices 102 associated with the user(s) with a known audio signature typically associated with a particular location.

The mobile computing device 102 operated by an active member of the application or system can be configured to connect to a cloud-based infrastructure. In some variations, the cloud-based infrastructure may be private or may be public. Communication between mobile computing device(s) 102 and the cloud-based infrastructure can be facilitated using protocols such as HTTP, RTP, XIVIPP, CoAP or other alternatives. These protocols can in-turn leverage private or public wireless or wireline infrastructure such as Ethernet, Wi-Fi, Bluetooth, NFC, RFID, WAN, Zigbee, powerline and others.

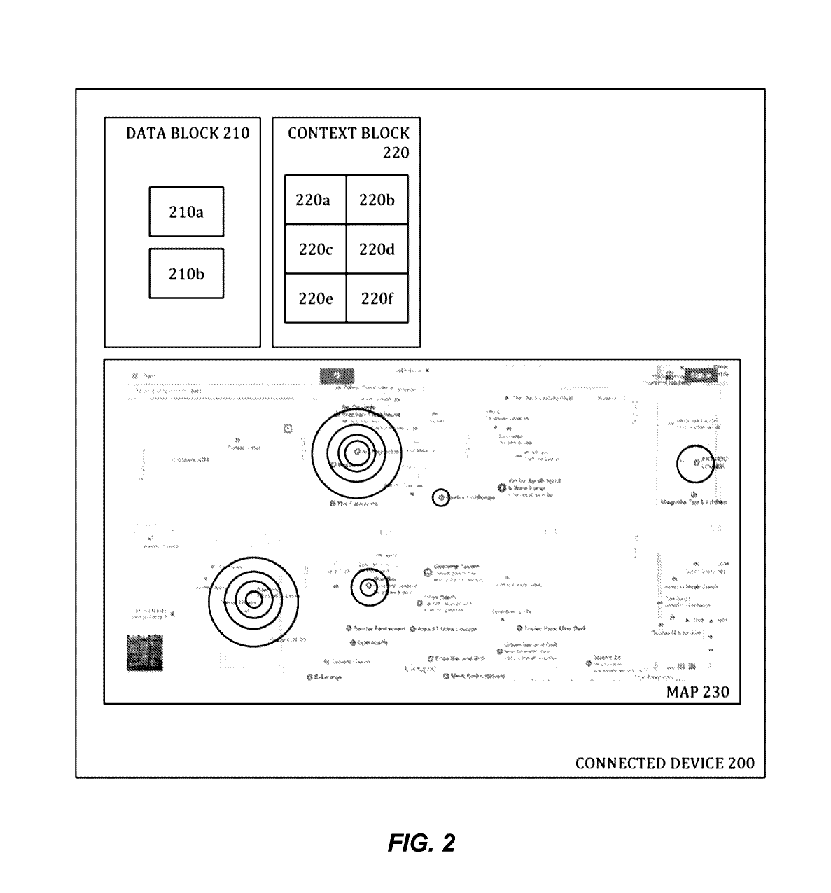

FIG. 2 illustrates a schematic representation of a mobile computing device 200 associated with a system having one or more elements consistent with the present description. The mobile computing device 200 can be configured to present. The mobile computing device may include a data processor 210. The data processor 210 can be configured to receive and process sound signals. The sound signals can be used to generate a sound scene associated with a region in the vicinity of the mobile computing device 200. For example, a sound scene may represent a busy restaurant where a baby starts crying. Other examples of sound scenes can include determining keywords spoken by a human, the presence of wind noise, human chatter, object noise and other ambient sounds. The data processor 210 can be configured to compare received acoustic information with acoustic information stored in a database 210a. The database 210a may be on the mobile computing device 200 or may be located at a remote location, for example, on a server, such as server 106, illustrated in FIG. 1.

Sounds obtained by the mobile computing device 200 may be filtered in real-time or near-real-time. In some variations, a sound filter 210b, located on the mobile computing device 200 or a remote computing device, can be configured to detect voice samples. The sound filter 210b can be configured to filter out ambient sounds from the acoustic information obtained at the mobile computing device 200. In some variations, the mobile computing device and/or remote computing device can be configured to mute, remove, or delete any user-generated voice samples to maintain privacy of the user associated with the mobile computing device 200. In some variations, voice samples not related to the user of the mobile computing device 200 (for example, from other users present in the sound scene) may not get filtered because they may be important to assess the composition of the scene, such as a crowded bar.

Context can be applied to a sound scene. The mobile computing device 200 can include context processors 220. The context processors 220 may be the same processors as the data processors 210 or may be different processors. The functions of the context processors 220 may be performed by one or more of the mobile computing device 200, a remote computing device, or the like. The context processors 220 can be configured to obtain contextual information from the acoustic information obtained at the mobile computing device 200.

Contextual information may be obtained from one or more sensors of the mobile computing device 200. For example, the mobile computing device 200 may include a GPS sensor 220a, a clock 220b, motion sensors 220c (for example, accelerometers, gyroscopes, magnetometers, or the like), environmental sensors 220d (for example, temperature, barometer, humidity sensor, light sensor, or the like). Context information can be obtained from analyzing the acoustic information obtained from the mobile computing device 200. Context information can include an activity type in 220e, an emotional state 220f of the user of the mobile computing device 200.

Contextual information associated with previously obtained acoustic information can be queried, this may be referred to as historical contextual information. Querying can be performed by the mobile computing device 200, a server, remote computing devices, or the like. The historical contextual information may be queried in real-time or near-real-time. For example, if there is a blackout during a game day at a stadium preventing access to live and/or near-real-time information upon which to determine a context, the presently described system can use historical context information to determine a context of the acoustic information obtained at the mobile computing device.

The mobile computing device 200 can be configured to generate a sound map. The sound map can be visual, touch-based, audio-based, haptic-feedback-based, or the like. For example, a mobile computing device can be configured to vibrate based on the contextual sound map. In other variations, in response to determining a context of acoustic information, an alert can be provided to the user. The alert can be a notification, a sound, or the like. In some variations, the based on the context of the acoustic information, a third-party device can be triggered to perform an action. For example, a mobile computing device in proximity to a third-party display may cause the third-party display to present a notification to the user of the mobile computing device.

The mobile computing device 200 can be configured to display a graphical representation of a contextual sound map 230. The contextual sound map 230 can be presented on a display of the mobile computing device 200. In some variations, the mobile computing device 200 can be configured to display the contextual information associated with the sound scene on a display in lieu of the contextual sound map 230. For example, the user of the mobile computing device 200 could query a server, such as server 200, to determine which bars in a specific location are busy, based on the level of noise in the bars at particular times of day.

The contextual sound map 230 can be configured to include a graphical indication of both sound and audio information. The contextual sound map 230 can include non-sound information augmenting the map.

In some variations, a visual map can be generated showing acoustically active or passive regions in a given location. The regions can be classified and labelled by order of magnitude of the sound activity. The sound information within the map can be crowd-sourced from a plurality of active members and/or from passive members across audible or inaudible frequencies. Obtaining sound information can be obtained either through a pre-determined schedule, based on a plurality of triggers, based on machine learning algorithms, or the like.

The visual map can be updated in real-time or near-real-time. The visual map can be configured to show time-lapsed versions of the visual map, a cached version of the visual map, a historical version of the visual map, and/or a predicted future version of the visual map. The visual map can be presented on a mobile computing device, for example, a Smartphone, Tablet, Laptop or other computing device. The visual map can be generated by a mobile computing device, a remote computer, a server, or the like.

The visual sound map can be classified by types of sound activity such as human noise, human chatter, machine noise, recognizable machine sounds, ambient noise, recognizable animal sounds, distress sounds, and the like. For example, the system installed in an off-shore oil rig with running machinery powered by passive user members can provide a sound map whilst instantly detecting abnormalities in machine hum and sounds preempting a visual inspection ahead of impending severe or catastrophic damage to life and/or equipment.

In some variations, a visual sound map can be integrated with other layered current or predictive information such as traffic, weather, or the like. The other layered current or predictive information that allows a user of the system to generate a plurality of customizable views. For example, a user of the system can generate the fastest route between two points of interest avoiding noisy neighborhoods (suggesting a crowded area) in correlation with real-time traffic patterns on roads.

In some variations, the visual sound map can be configured to export correlated information derived from several of its visualization layers via suitable application programming interfaces (APIs) for use in other services such as targeted advertisements, search engines such as Google, Bing and Yahoo, social media platforms such as Facebook, Twitter, Instagram, Yelp and Pinterest, traditional mapping services such as Waze, Google Maps, Apple Maps and Here Maps which can increase user engagement, generate higher advertisement impression rates and offer value-added benefits. For example, the cost per thousand impressions (CPM) for an advertisement can be conceivably higher for placement of an advertisement in a crowded area as opposed to one that isn't.

The visual sound map can be further curated based on localization and language-specific parameters. For example, the demographic information, including nationality, culture, or the like can be obtained. Demographic information can be obtained based on identifiable audio signatures of users in an area. A visual sound map can be curated based on the identified demographic information. For example, a peaceful demonstration of people shouting slogans in Spanish can be valued higher than a service that just detects the presence of a large gathering of people. That information in-turn can allow other services to act on it such as informing Spanish-language news agencies or journalists of the event so they can reach that location and cover the event as it unfolds. On the other hand, a hostile demonstration involving rioters breaking glass and other equipment in addition to shouting slogans in Spanish can be useful to understand to inform public safety agencies proficient in conversing in the Spanish language to intervene and take action. Under normal circumstances, such scenarios would take a long time to understand. The presently described subject matter allows for the parsing of the situation in real-time and in most cases the right choice actions being taken soon thereafter.

In some variations, mobile computing device 102 can be configured to emit sound and measure the time it takes for echoes of the sound to return. The sound emitted can be in an audible or inaudible frequency range. In some variations, a passive user members installed on public infrastructure such as traffic signs or light poles can perform coarse range detection of stationary or moving targets within the vicinity by emitting and measuring back emitted ultrasonic signals. Coarse shape of the target may be detected using the emitted and rebounded sound signals.

Emitted and rebounded sound signals can facilitate navigating potholes on a road, or the like. A system can be provided that is configured to sweep the area in front of the automobile and visualize, through sound, a map of the road as navigated by the automobile. The map can show abnormal road conditions detected by the system. Existing techniques to determine the existence of potholes are limited to motion sensors on the automobile that detect when it drives over a pothole or requiring people to manually provide an input into a software application. This system can allow detection of the terrain whether or not the automobile drives over it.

With reference to FIG. 1, in some variations, an offer can be presented to a user of the mobile computing device 200. The offer presented to the user of the mobile computing device 200 can have an offer attribute. The offer attribute can match the context attribute and a location attribute matching the location information.

The offer may include a targeted advertisement. The targeted advertisement may be driven by audio intelligence. The audio intelligence may use the context of the acoustic information obtained by the mobile computing device 200. The offers may be provided based on the context of the acoustic information. For targeted advertisements, a publisher of the targeted advertisements may desire adverts to be targeted at individuals in particular locations when those locations have a particular sound scene. For example, targeted advertisements can be directed toward customers at an establishment where there is a lot of noise versus one that has not much noise, or vice-versa. Targeted advertisements can be adaptively delivered to recipients based on detection of unique sound signatures. For example, if a user is waiting at an airport, the sound signature of the ambient environment can be assessed and paired with a contextually-relevant set of advertisements, for example, advertisements related to travel, vacations, or the like.

Advertising can be provided through digital billboards, advertising displays, or the like. For example, a digital signage display in an airport may be used to identify if a child is viewing the display as opposed to a full-grown adult. Furthermore, the mood of the child (e.g. crying) can be identified and the system can be configured to tailor an appropriate advertisement such as a tempting chocolate or messages related to animals or toys that may bring cheer to the child, as opposed to showing pre-scheduled advertisements that may not be relevant to the child at all (e.g. an advertisement showing the latest cell phone).

Geolocation technology can be augmented using sound signatures obtained at the mobile computing device 200. Sound signatures obtained by the mobile computing device can be compared with sound signatures stored in a database 110 and/or other mobile computing devices 112. For example, in a sports stadium, it is possible to identify the section(s) of users using a mobile computing device 200 that are cheering the loudest. Such information can then be processed to enable offers to be provided to users, including promotions, contests and other features to increase fan and customer engagement, or the like.

A machine learning system can be employed by the mobile computing device 102, the server 106, or the like, and configured to facilitate continuous tracking of sound signatures in a given location and estimating based on it. For example, a machine learning system associated with a mobile computing device 102 can be configured to estimate the time that it takes a train to arrive into a station based on its sound signature as it approaches the terminal. Where visual inspection isn't available or practically feasible sound signatures can be leveraged to provide additional information. For example, in a foggy location, an approaching aircraft or automobile can be detected through its sound signature faster and more accurately than through visual inspection. This information can be provided to the operator of the aircraft and/or vehicle to facilitate safe operation of the aircraft and/or vehicle.

Mobile computing devices 102 can include: smartphones including software and applications to process sound information and provide feedback to the user; hearables with software and applications that work either independently or in concert with a host device (for example, a Smartphone). Hearables can include connected devices that do not need or benefit from a visual display User Interface (UI) rely solely on audio input and output. Such devices can be termed as ‘Hearables’. This new class of smart devices can either be part of the Internet of Things (IoT) ecosystem or the consumer wearables industry. Here are some examples:

Mobile computing devices 102 can be incorporated into public infrastructure such as hospitals, first-responder departments such as police and fire, street lights or other outdoor structures that can be embedded with the invention. Mobile computing devices 102, servers 106, or the like can be disposed in private infrastructure such as a theme park, sports arena with local points-of-interest such as an information directory, signboards, performance venues, etc, cruise ships, aircraft, buses, trains and other mass-transportation solutions.

The mobile computing device 102 can include a hearing aid, in-ear ear-buds, over the ear headphones, or the like. The sound response of a hearing aid or similar in-ear or around-the-ear device can be dynamically varied based on known ambient noise signatures. For example, a hearing aid or similar device can automatically increase its gain when the user enters a crowded marketplace where the ambient sound signature in terms of signal-to-noise ratio may not vary much from day-to-day. Given that the method is able to store historical sound signatures for specific locations either on-device or fetch it dynamically from a server, the hearing aid or similar device can now alter its performance dynamically to provide the best sound experience to the user.

Mobile computing devices 102 can be disposed within: automobiles such as cars, boats, aircraft where the invention can be embedded into the existing infrastructure to make decisions based on the sound signature of the ambience; military infrastructure for preventing a situation from happening or for quick tactical response based on sound signatures determined by the embedded invention; and disaster response infrastructure wherein detecting unique sound signatures may be able to save lives or be able to respond to attend to human or material damage. For example, a drone embedded with the invention could scan a given area affected by disaster to detect the presence of humans, animals, material property and other artifacts based on pre-determined or learned sound signatures.

A mobile computing device 102, server 106, and/or other computing devices can include a processor. The processor can be configured to provide information processing capabilities to a computing device having one or more features consistent with the current subject matter. The processor may include one or more of a digital processor, an analog processor, a digital circuit designed to process information, an analog circuit designed to process information, a state machine, and/or other mechanisms for electronically processing information. In some implementations, the processor(s) may include a plurality of processing units. These processing units may be physically located within the same device, or the processor may represent processing functionality of a plurality of devices operating in coordination. The processor may be configured to execute machine-readable instructions, which, when executed by the processor may cause the processor to perform one or more of the functions described in the present description. The functions described herein may be executed by software; hardware; firmware; some combination of software, hardware, and/or firmware; and/or other mechanisms for configuring processing capabilities on the processor.

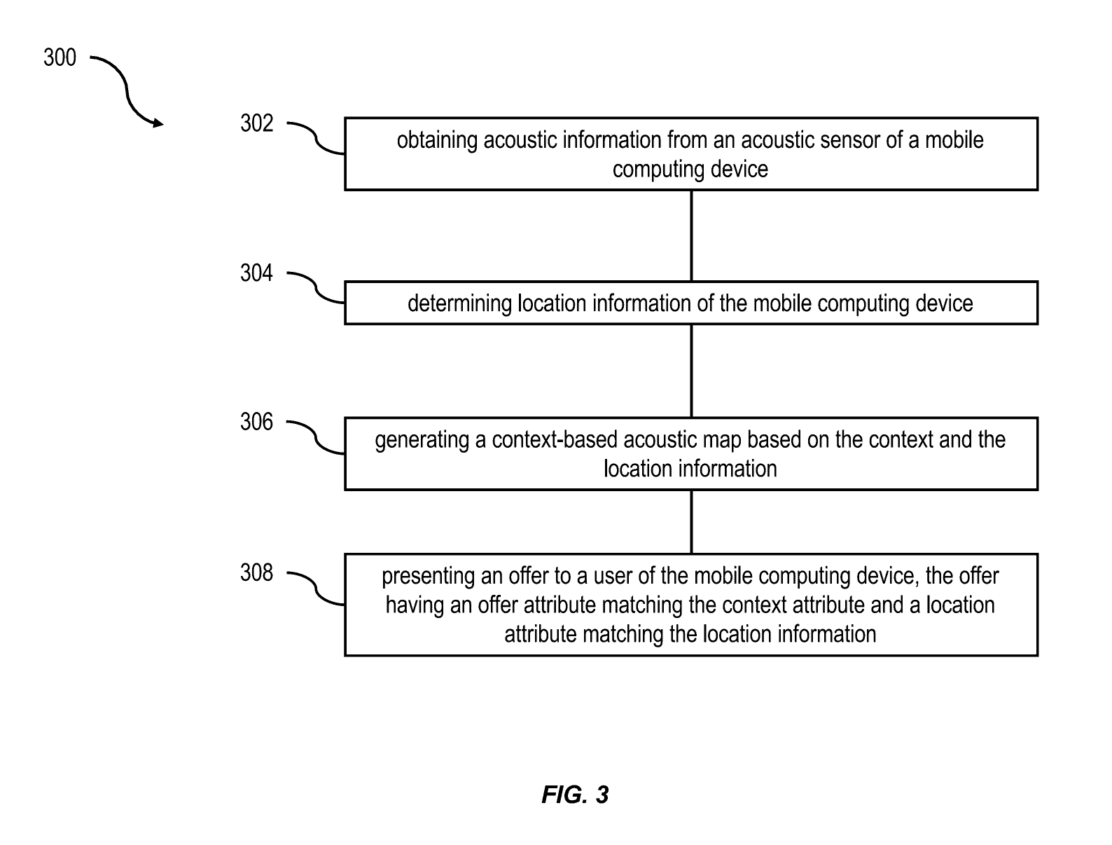

FIG. 3 illustrates a method 300 having one or more features consistent with then current subject matter. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 302, acoustic information can be obtained from an acoustic sensor of a mobile computing device. In some variations, the acoustic information can be obtained from a plurality of acoustic sensors of a plurality of mobile computing devices. The plurality of mobile computing devices belong a user group having a plurality of users, the plurality of users having at least one common attribute.

At 304, location information of the mobile computing device can be determined. Geographical coordinates from a geographical location sensor of the mobile computing device can be obtained. The obtained acoustic information can be compared with a database of acoustic profiles, the acoustic profiles associated with geographical locations. The obtained acoustic information from a first mobile computing device of the plurality of mobile computing devices can be compared with obtained acoustic information from other mobile computing device of the plurality of mobile computing devices.

An acoustic type of acoustics associated with the obtained acoustic information can be determined. One or more entity types capable of generating acoustics having the acoustic type can be determined. In some variations, the acoustic type can be human speech and a transcript of the human speech can be generated. A context of the human speech can be determined. The context of the acoustic information may then have a context attribute indicating a subject of the human speech.

At 306, a context-based acoustic map can be generated based on the context and the location information. A map of a geographical region associated with the location information of the mobile computing device can be obtained. A graphical representation of the context of the acoustic information can be overlayed on the map.

At 308, an offer can be presented to a user of the mobile computing device. The offer can have an offer attribute matching the context attribute and a location attribute matching the location information. The offer may have an offer attribute consistent with the subject of the human speech.

In some variations, the method may include predicting a likely future event based on a context trend obtained by observing acoustic information over a period of time. The offer presented to the user may be associated with the likely future event.

In some variaitons, real-time audio power and/or intensity of ambient noise may be determined. This may be determined in an environment that a plurality of users may find themselves in. A typical example of such measurement is referred to as the Noise Floor measured in decibels (dB) and its variants.

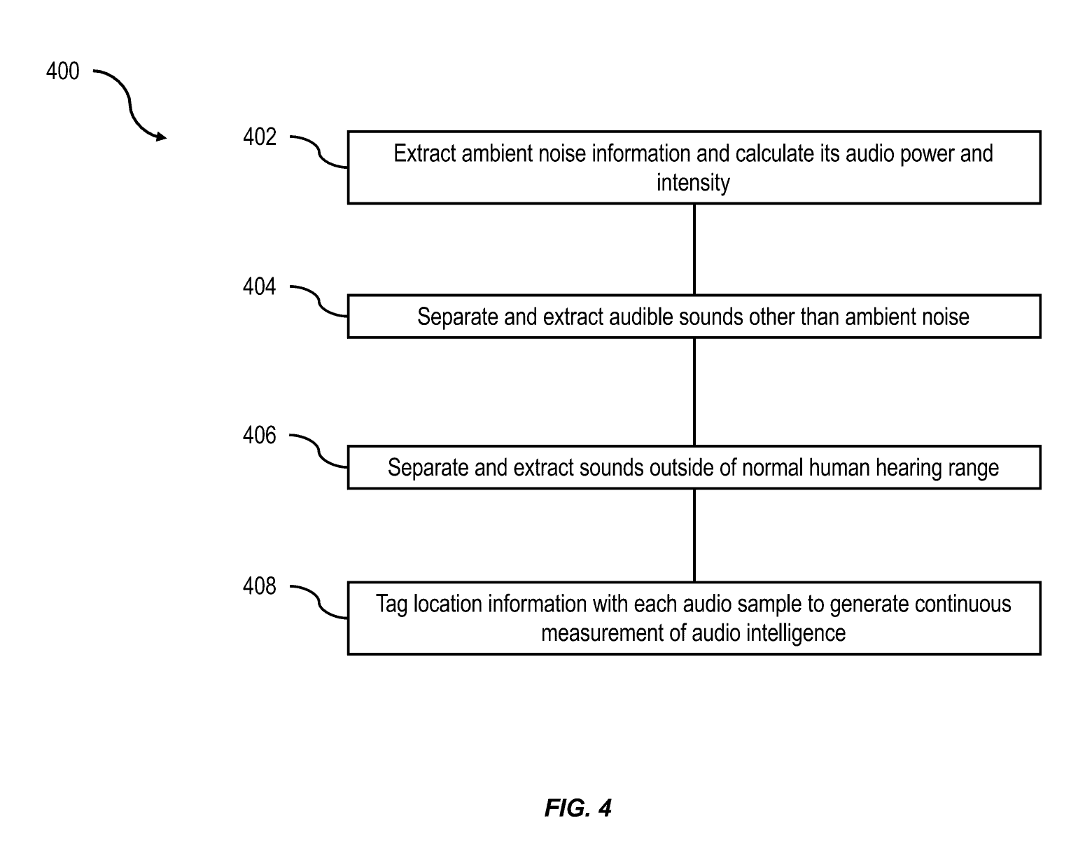

FIG. 4 illustrates a method 400 having one or more features consistent with then current subject matter. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At 402, specific sound information can be separated and extracted. The specific sound information can be sound information other than ambient noise that has relevance to the embodiments of the present invention, such as (1) Wind Noise, (2) Human Voice (singular), (3) Human Voice (plural), (4) Animal Sounds, and (5) Object Sounds.

At 404, method 400 may include, for example, separating and extracting sounds that are outside the range of human hearing, such as those that fall within the Ultrasound frequencies (20 kHz-2 MHz) and Infrasound frequencies (less than 20 kHz).

At 406, the method 400 may include, a measurement unit can be used to represent real-time audio intelligence in terms of dB measured over time for a plurality of points-of-interest on a map and classified according to date and time of day. An example of such a measurement could be: −50 dBm measured at a sports bar between 6 PM-9 PM on Fri., Jun. 19 2015.

At 408, location information can be tagged to each audio sample to generate continuous measurement of audio intelligence.

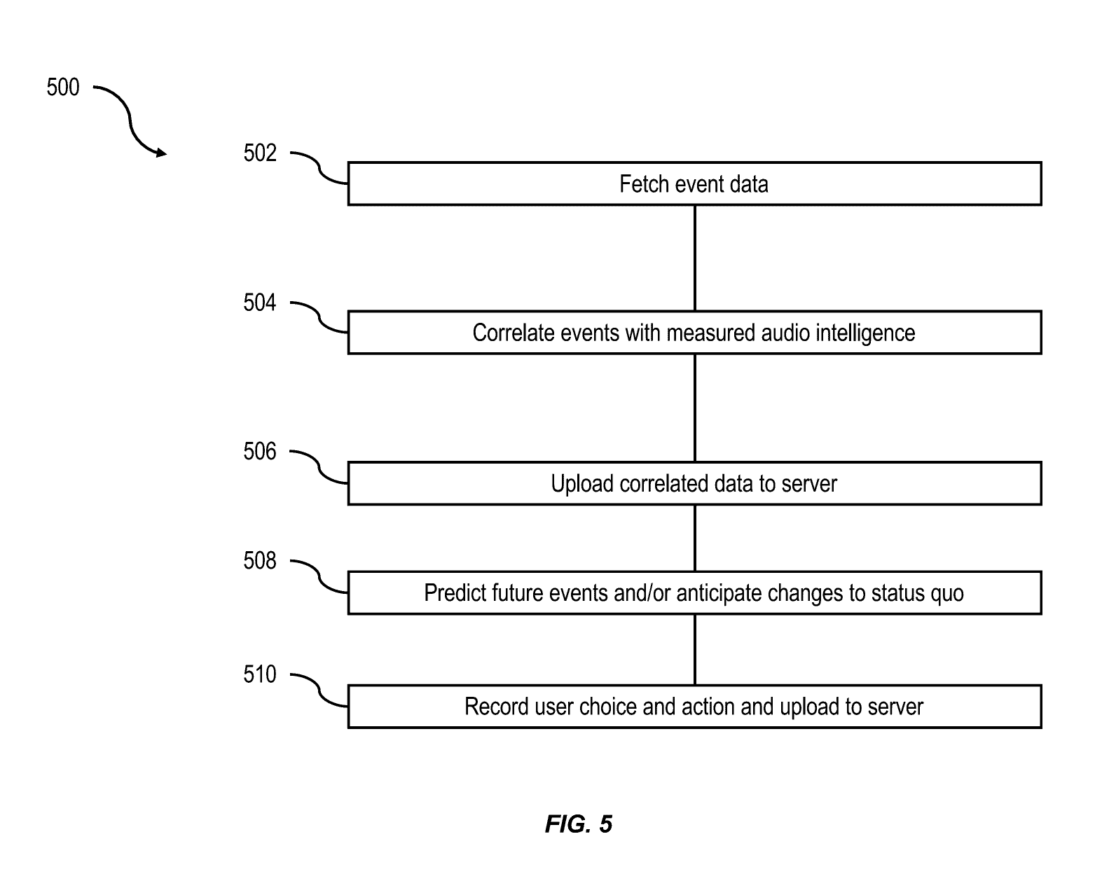

FIG. 5 illustrates a method 500 having one or more features consistent with then current subject matter. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At 502, the method 500 may include, for example, fetching, understanding and classifying a plurality of events from the past or ones that are happening in real-time. Such events may be sourced from a server or from a plurality of users using the present invention.

At 504, the method 500 may include, for example, correlating events past and present as described at 502 to the measured audio intelligence information (as described with respect to in FIG. 4). For example, a commonly experienced event corresponding to a sports team winning a game can be correlated to the measured audio intelligence over a period of time, in a sports bar (a typical point-of-interest).

At 506, the correlated data may be uploaded to a server for real-time use in decision-making.

At 508, the method 500 may include, for example, the ability to predict future events or anticipate changes to the status quo. For example, it may be possible to estimate that a specific sports bar may be filling-up quickly with people compared to other such establishments, based on a surge in measured audio intelligence in the said bar by comparing its measurements to that of other establishments that may be available real-time on the server. Such information may be able to help a plurality of users to make appropriate decisions on whether or not to enter the crowded sports bar in favor of one that may still have room.

At 510, the method 500 may include, for example recording of actions and choices from a plurality of users based on the options provided by the present invention as described at 508.

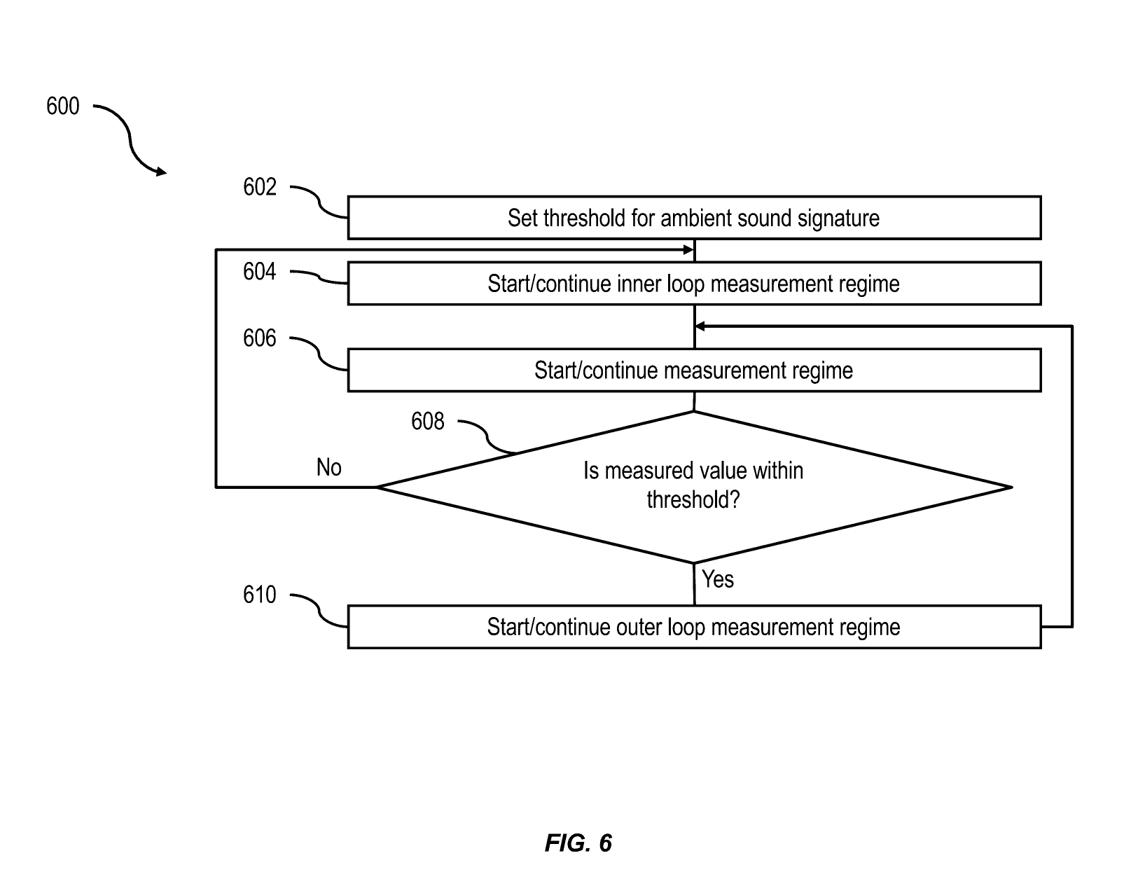

FIG. 6 illustrates a method 600 having one or more features consistent with then current subject matter. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At 602, the method 600 may include, for example, dynamically assessing the frequency of measurement of the ambient sounds by first setting a threshold for the ambient sound signature.

At 604, the method 600 may use an algorithm involving an inner loop measurement regime.

At 610, the method 600 may use an algorithm involving an outer loop measurement regime.

At 606, the method 600 provides for continuous measurement of the ambient sound signature based on the regime. The method may also prescribe flexibility in designing the thresholds at 602 for each transition from outer to inner loop. It also may prescribe the step increments to thresholds at 602 between each loop transition if need be.

Should the ambient sound signature not vary beyond the threshold, as evidenced at 608, the measurement regime stays in the said loop. The loop transition occurs only when the ambient sound signature starts varying beyond the said threshold between measurements.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method to be performed by at least one computer processor forming at least a part of a computing system, the method comprising:
obtaining acoustic information from an acoustic sensor of a mobile computing device;
determining location information of the mobile computing device;
determining a context of the acoustic information, the context having a context attribute;
generating a context-based acoustic map based on the context and the location information; and
presenting an offer to a user of the mobile computing device, the offer having an offer attribute matching the context attribute and a location attribute matching the location information.

2. The method of claim 1, further comprising:
obtaining acoustic information from a plurality of acoustic sensors of a plurality of mobile computing devices.

3. The method of claim 2, wherein the plurality of mobile computing devices belong to a user group having a plurality of users, the plurality of users having at least one common attribute.

4. The method of claim 1, wherein the determining of location information comprises:
obtaining geographical coordinates from a geographical location sensor of the mobile computing device.

5. The method of claim 1, wherein the determining of the location information comprises:
comparing the obtained acoustic information with a database of acoustic profiles, the acoustic profiles associated with geographical locations.

6. The method of claim 1, wherein the determining of the location information comprises:
comparing the obtained acoustic information from a first mobile computing device of the plurality of mobile computing devices with obtained acoustic information from other mobile computing device of the plurality of mobile computing devices.

7. The method of claim 1, wherein the determining the context of the acoustic information includes:
determining an acoustic type of acoustics associated with the obtained acoustic information; and
determining one or more entity types capable of generating acoustics having the acoustic type.

8. The method of claim 7, wherein the determining of the context of the acoustic information includes:
determining that the acoustic type is human speech; generating a transcript of the human speech; and
determining a context of the human speech, wherein the context has a context attribute indicating a subject of the human speech.

9. The method of claim 8, wherein presenting the offer to the user comprises:
selecting an offer having an offer attribute consistent with the subject of the human speech.

10. The method of claim 1, wherein the context attributes are associated with geographical locations.

11. The method of claim 1, wherein generating a context-based acoustic map comprises:
obtaining a map of a geographical region associated with the location information of the mobile computing device; and
overlaying on the map a graphical representation of the context of the acoustic information.

12. The method of claim 1, wherein the offer is presented to the user on a display device of the mobile computing device.

13. The method of claim 1, wherein the offer is presented in proximity to a subject of the offer.

14. The method of claim 2, further comprising:
receiving acoustic information from the plurality of acoustic sensors over a period of time;
determining a context trend based on the context of the acoustic information received over the period of time; and,
predicting a likely future event based on the context trend,
wherein the offer to the user is associated with the likely future event.

15. A system comprising:
a processor; and,
a memory storing machine-readable instructions, which when executed by the processor, cause the processor to perform one or more operations, the operations comprising:
obtaining acoustic information from an acoustic sensor of a mobile computing device;
determining location information of the mobile computing device;
determining a context of the acoustic information, the context having a context attribute;
generating a context-based acoustic map based on the context and the location information; and
presenting an offer to a user of the mobile computing device, the offer having an offer attribute matching the context attribute and a location attribute matching the location information.

16. The system of claim 15, wherein the operations further comprise, at least:
obtaining acoustic information from a plurality of acoustic sensors of a plurality of mobile computing devices.

17. The system of claim 15, wherein the determining of location information comprises:
obtaining geographical coordinates from a geographical location sensor of the mobile computing device.

18. The system of claim 15, wherein the determining of the location information comprises:
comparing the obtained acoustic information with a database of acoustic profiles, the acoustic profiles associated with geographical locations.

19. The system of claim 15, wherein the determining the context of the acoustic information includes:
determining an acoustic type of acoustics associated with the obtained acoustic information; and
determining one or more entity types capable of generating acoustics having the acoustic type.

20. The system of claim 15, wherein generating a context-based acoustic map comprises:
obtaining a map of a geographical region associated with the location information of the mobile computing device; and
overlaying on the map a graphical representation of the context of the acoustic information.
